(19) United States
(12) Patent Application Publication
(10) Pub. No.: US 2024/0039332 A1
(43) Pub. Date: Feb. 1, 2024

(54) TRANSMITTER AND RECEIVER PADS FOR INDUCTIVE POWER TRANSFER

(71) Applicant: INTDEVICE LIMITED, Auckland (NZ)

(72) Inventors: Li Jun YU, Auckland (NZ); Yuan SONG, Auckland (NZ); Haozhuo LING, Auckland (NZ)

(73) Assignee: INTDEVICE LIMITED, Auckland (NZ)

(21) Appl. No.: 18/268,491

(22) PCT Filed: Dec. 15, 2021
(86) PCT No.: PCT/IB2021/061741

§ 371 Date: Jun. 20, 2023

(30) Foreign Application Priority Data
Dec. 17, 2020 (NZ) 771120

(51) Int. Cl. H02J 50/00; H02J 50/10; H02J 50/70

(52) U.S. Cl. CPC H02J 50/005; H02J 50/10; H02J 50/70

(57) ABSTRACT

A WPT transmitter pad comprising: a cover, a coil, a metallic frame, and a frame magnetic sheet between the metallic frame and the cover.

### BACKGROUND

Generally, wireless power transfer (WPT) is a technology which enables transferring power from a primary/transmitter side wirelessly to desired devices (pick-up/receiver/load side).

To transfer power, a primary coil in the transmitter is energized by AC currents, which generate time-varying magnetic fields or magnetic flux. The strength of the generated magnetic field depends on AC currents and permeability of space in accordance with Ampere's Law. A portion of the generated time-varying magnetic field links with a pick-up coil in the receiver side to induce voltages according to Faraday's Law. The linked magnetic field or magnetic flux is referred to as coupling and expressed as coupling coefficients k. Basically, with a given AC current and space permeability, the higher coupling coefficients k, the higher induced voltages across the pick-up conductor.

A pair of traditional WPT pads 10 (primary/transmitter pad 11, secondary/pick-up, receiver pad 12) used for wireless power transfer is show in FIG. 1. Generally, WPT coils 16, 17 are sealed inside pads 11, 12 with galvanic insulation frames 13, 14 and covers 18, 19. The major problems are heat dissipation, coupling coefficients k and losses on metallic objects due to eddy currents.

### SUMMARY OF INVENTION

It is an object of the invention to provide a WPT transmitter and/or receiver pad with improved heat dissipation and/or k and/or improved eddy losses.

In one aspect the present invention may be said to comprise a WPT transmitter pad comprising: a cover, a coil, a metallic frame, and a frame magnetic sheet between the metallic frame and the cover.

Optionally the WPT transmitter comprises a metallic base plate.

Optionally the WPT transmitter further comprises a coil magnetic plate.

Optionally the frame magnetic sheet extends beyond the external perimeter of the metallic frame.

Optionally the frame magnetic sheet extends beyond the internal perimeter of the metallic frame.

Optionally the frame magnetic sheet is disposed between the metallic frame and the cover.

Optionally the frame magnetic sheet is spaced from the cover.

Optionally the frame magnetic sheet is spaced from the metallic frame.

Optionally the frame magnetic sheet is spaced from the coil magnetic plate.

Optionally the metallic frame is spaced from the frame magnetic sheet.

Optionally the metallic frame is spaced from the metallic base plate.

Optionally the metallic frame is spaced from the coil magnetic plate.

Optionally the metallic frame is shaped to improve heat dissipation.

Optionally the WPT transmitter further comprises one or more fans.

Optionally the WPT transmitter further comprises liquid cooling.

Optionally the frame magnetic sheet and/or coil magnetic plate are made from one or more of:
ferromagnetic material,
ferrimagnetic material, or
nanocrystalline material,
   and/or can be for example be:
ferrite,
manganese-zinc ferrite,
nickel-zinc ferrite.

In another aspect the present invention may be said to consist in a WPT receiver pad comprising: a cover, a coil, a metallic frame, and a frame magnetic sheet between the metallic frame and the cover.

Optionally the WPT transmitter further comprises a metallic base plate.

Optionally the WPT transmitter further comprises a coil magnetic plate.

Optionally the frame magnetic sheet extends beyond the external perimeter of the metallic frame.

Optionally the frame magnetic sheet extends beyond the internal perimeter of the metallic frame.

Optionally the frame magnetic sheet is disposed between the metallic frame and the cover.

Optionally the frame magnetic sheet is spaced from the cover.

Optionally the frame magnetic sheet is spaced from the metallic frame.

Optionally the frame magnetic sheet is spaced from the coil magnetic plate.

Optionally the metallic frame is spaced from the frame magnetic sheet.

Optionally the metallic frame is spaced from the metallic base plate.

Optionally the metallic frame is spaced from the coil magnetic plate.

Optionally the metallic frame is shaped to improve heat dissipation.

Optionally the WPT transmitter further comprises one or more fans.

Optionally the WPT transmitter further comprises liquid cooling.

Optionally the frame magnetic sheet and/or coil magnetic plate are made from one or more of:
ferromagnetic material,
ferrimagnetic material, or
nanocrystalline material,
   and/or can be for example be:
ferrite,
manganese-zinc ferrite,
nickel-zinc ferrite.

In another aspect the present invention may be said to comprise a WPT system comprising a transmitter pad according to any of the preceding paragraphs and a receiver pad according to any one or more of the preceding paragraphs.

In one aspect the present invention may be said to comprise a WPT pad comprising: a cover, a coil, a metallic frame, and a frame magnetic sheet between the metallic frame and the cover. Optionally the WPT pad can be a receiver pad. Optionally the WPT can be a transmitter pad. Optionally the WPT can have any one or more of the features according to any one or more the preceding paragraphs.

Optionally a WPT pad (such as a WPT receiver and/or WPT transmitter pad) as per any one or more of the preceding paragraphs comprises potting compound to assist in dissipating heat.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner. Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

### BRIEF DESCRIPTION OF DRAWINGS

Embodiments will now be described with reference to the accompanying drawings, of which:

FIG. 1 shows a traditional WPT pad.

FIG. 2 shows a WPT pad according to present embodiments.

FIG. 3A, 3B 3C shows a cross-section of a WPT transmitter pad in full and close-up, and in plan.

FIG. 4A, 4B 4C show a cross-section of a WPT receiver pad in full and close-up, and in plan.

FIG. 5A, 5B, 5C show the trade-off between sizes of A, B and F versus eddy current and magnetic losses.

FIG. 5D, 5E, 5F show the trade-off between sizes of I, J and N versus eddy current and magnetic losses.

FIG. 6A, 6B show the temperature comparisons between traditional transmitter/receiver pads and the transmitter/receiver pads as described herein.

FIG. 7 shows the k difference between a pad as described herein versus a pad with no frame magnetic sheet.

FIG. 8 shows the eddy loss comparisons between transmitter/receiver pads without frame magnetic sheets and the transmitter/receiver pads as described herein.

FIG. 9A, 9B show magnetic flux distribution and ohmic loss distribution on a traditional receiver pad.

FIG. 10A, 10B show magnetic flux distribution and ohmic loss distribution on a receiver pad as described herein.

FIG. 11A, 11B show a traditional transmitter/receiver pad with a fan behind the metallic base plate.

FIG. 12A, 12B show a transmitter/receiver pad as described herein with a fan behind the metallic base plate.

FIG. 13A, 13B show a traditional transmitter/receiver pad with a fan between the metallic base plate and coil magnetic frame.

FIG. 14A, 14B show a transmitter/receiver pad as described herein with a fan between the metallic base plate and coil magnetic frame.

FIG. 15A, 15B show a temperature comparison between traditional transmitter/receiver pads without a fan, and traditional transmitter/receiver pads with fans in the two positions.

FIG. 16A, 16B show a temperature comparison between transmitter/receiver pads without a fan, and traditional transmitter/receiver pads with fans in the two positions all as described herein.

FIG. 17A, 17B show WPT pads with liquid cooling for the metallic frame.

FIG. 18A shows a WPT pad with a metallic frame formed as a heatsink.

### DESCRIPTION

### 1. Overview

Traditional WPT transmitter/receiver pads 10 (transmitter 11, receiver 12) have drawbacks with heat dissipation and eddy losses, as they are both encapsulated and insulated by galvanic insulation frames 13, 14 and a cover 18, 19.

The materials used in the galvanic insulation frames 13, 14 and cover 18, 19 of such pads 10 are poor conductors of heat. The heat generated by coil 17, 16 losses and coil magnetic plates 9, 8 losses (core losses) cannot be dissipated sufficiently rapidly, and therefore, the temperature of WPT pads 10 will increase over time. Moreover, pick-up pads 12 are usually compact, which means pick-up pads 12 are more susceptible to temperature rises.

Insofar that there have been attempts by others to deal with heat dissipation, the solutions introduce other problems. For example, if the galvanic insulation material frames are replaced with good conductors of heat, the temperature of pick-up pads can be lower than that with non-metallic frames because the heat can be quickly conducted and dissipated through good conductors. However, good conductors of heat can be good conductors of electricity as well. They shield some magnetic flux linked between primary coils and pick-up coils, and therefore, the k coupling coefficient between the transmitting and pick-up pad drops dramatically and induced voltage decreases. This results in less effective power transfer.

Further, traditional WPT pads 10 have losses on the metallic plate. Flux induces eddy currents on the surface of conductive objects, which causes extra resistive losses or solid losses. It is referred to as eddy current effect.

A time-varying magnetic flux induces loops of electrical currents within conductors. These (eddy) currents flow in a closed loop through the resistance of conductors, in planes perpendicular to the magnetic flux and therefore, generate losses as heat in conductors. These losses on conductors, caused by eddy currents, are referred to as solid losses. Solid losses affect WPT systems efficiencies.

The present embodiments address these by providing a metallic frame and frame magnetic sheet arrangement to deal with these drawbacks. The metallic frame increase heat dissipation. It also reduces eddy currents in the metallic plate. The metallic frame can reduce k, and also can introduce new eddy current losses. However, the addition of the frame magnetic sheet, helps reduce the k reduction, and reduces eddy currents in the metal frame so that the total eddy current losses of the metallic frame and metallic plate are less than the eddy current losses in just the metallic plate of a traditional WPT pad 10. Note, the frame magnetic sheet will typically be thinner than the coil magnetic plate, hence it is referred to as a sheet. But this should not be considered limiting on its thickness.

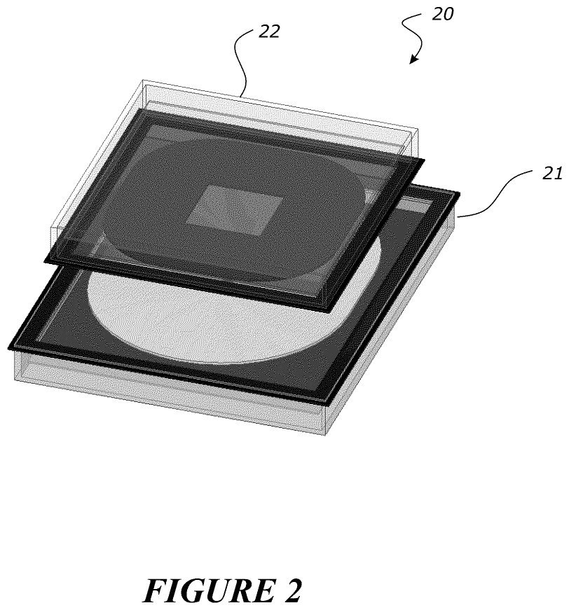

Referring to FIG. 2, the embodiments disclosed provide a structure of wireless power transfer (WPT) pad 20 (primary/transmitter pad 21, secondary/pick-up/receiver pad 22) with metallic frames and frame magnetic sheets to help heat dissipation, diminish metal shielding effects on coupling coefficients to maintain k at a desired value, and reduce solid losses (losses on metallic objects) due to eddy currents. In the embodiments, there are metallic frames with heights and distances to coil magnetic plates. The metallic frames are good heat conductors and allow for improved heat conduction in comparison to traditional WPT pad. Therefore, the heat generated by core losses and coil losses can be quickly conducted and dissipated through these metallic frames. But as previously noted a metallic element on its own can compromise the coupling coefficient and/or increase metallic plate losses. The combination of the metallic frame and frame magnetic sheet with particular dimensions and spacings as per design criteria provide for improved heat dissipation compared to a traditional primary transmitter pad, while still enabling a sufficient (e.g. maintaining) coupling coefficient K and enabling a reduction of losses in the metallic plates.

Herein, any reference to a WPT pad can be interpreted generally to mean and/or cover a WPT transmitter pad, a WPT receiver pad, or both.

### 2. WPT Pads—First Embodiment with Metallic Frames and Magnet Sheet

A first embodiment will now be described with reference to both the transmitter and receiver pads.

### 2.1 Transmitter Pad

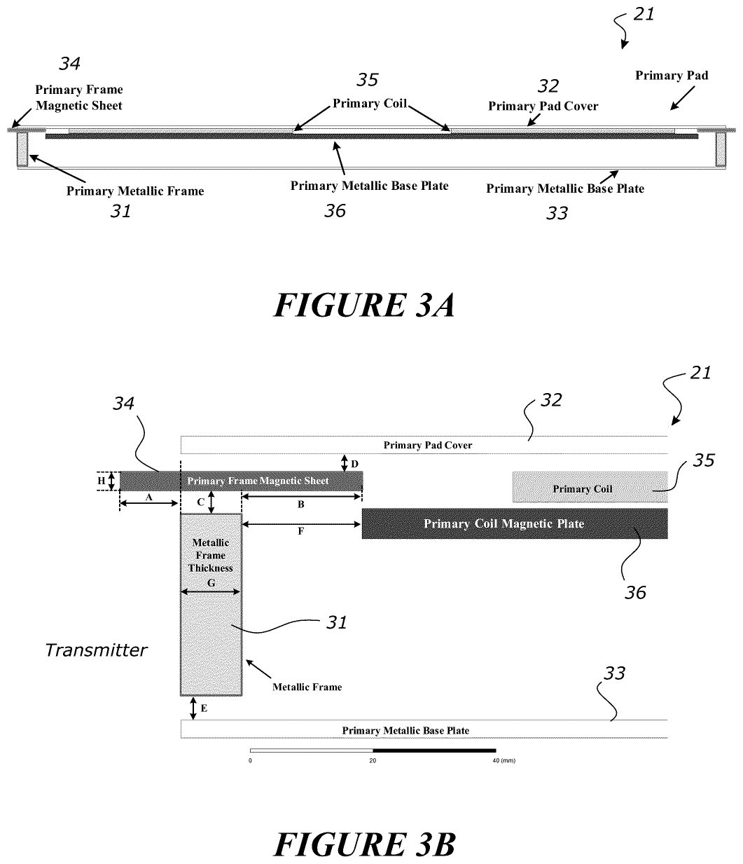

A transmitter pad 21 is shown in FIGS. 2, 3A, 3B and 3C. FIG. 3A shows a cross-section of the transmitter pad in diagrammatic form, FIG. 3B shows a cross-section each of the transmitter pad in further detail, FIG. 3C shows a plan view of the transmitter pad with primary frame magnetic sheets and FIG. 2 shows a perspective view of the transmitter pad sitting underneath a receiver pad. FIG. 3C shows exemplary dimensions, but this is by way of example only and should not be deemed limiting.

The transmitter pad 21 comprises a primary metallic base plate 33, and a primary coil 35 sandwiched between a primary pad cover 32 and a primary pad coil magnetic plate 36. This arrangement provides for inductive power transfer to a receiver pad 22 in the usual manner. The transmitter pad 21 also comprises a primary metallic frame 31 that extends as a side wall between the primary pad cover 32 and the primary metallic base 33, and a primary frame magnetic sheet 34 that is disposed between the primary metallic frame 31 and the primary pad cover 32. The coil magnetic plate 36 and the frame magnetic sheet 34 can be made from any material with magnetic properties, such as ferromagnetic material, ferrimagnetic material, or nanocrystalline material, and can be for example ferrite, manganese-zinc ferrite, nickel-zinc ferrite etc. The coil magnetic plate and frame magnetic sheet can be made from the same or different magnetic materials.

The primary metallic frame 31 allows for improved heat conduction in comparison to traditional primary pads, but as previously noted a metallic element on its own can compromise the coupling coefficient k and/or increase metallic plate losses. The combination of the primary metallic frame 31 and primary frame magnetic sheet 34 and their relative positioning provide for improved heat dissipation compared to a traditional primary transmitter pad 11, while still enabling a sufficient coupling coefficient k and enabling a reduction of losses in the metallic plates.

In particular, the primary metallic frame 31 and the primary frame magnetic sheet 34 can be arranged according to the following design criteria, to achieve the improved outcomes described herein. One or more of these design criteria can be applied. Not all design criteria are required, nor essential. They just provide options for more optimised solutions. Any arrangement of frame magnetic plate and metallic frame might achieve an acceptable outcome, whether or not they follow these criteria. That said, at this point, design criteria comprising dimensions A, B and F have been preferred from current simulations.

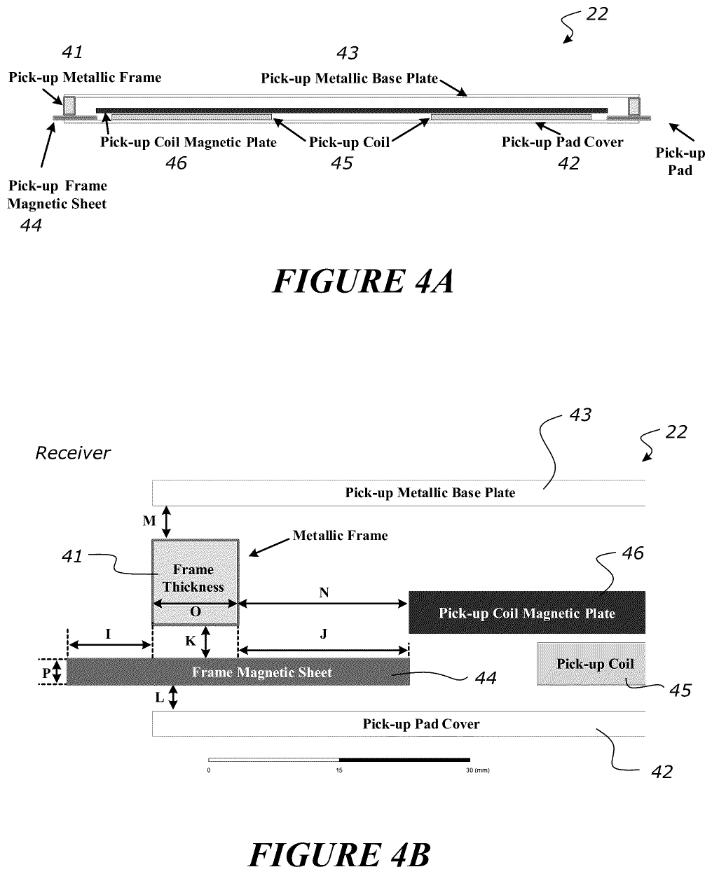

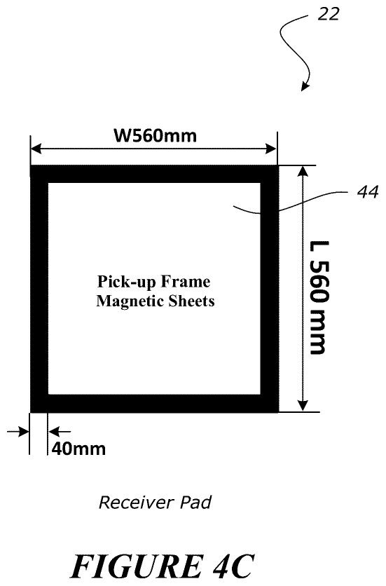

It should be noted that the trade-offs mentioned are between a criteria dimension being too big, creating a pad that is too large and/or heavy and a criteria dimension being too small to provide a benefit in terms of heat dissipation, reduction in k reduction, and reduction of eddy losses.
The primary frame magnetic sheet 34 is arranged to protrude A from the primary metallic frame 31 outer perimeter/side. This protrusion decreases the eddy current loss on primary metallic frames and maintains coupling k. The more protrusion, the less eddy current losses on metallic frames and better coupling k maintain. However, this protrusion increases entire pad 21 size/weight and coil magnetic plate losses. It is a trade-off between the pad size/weight, and beneficial heat dissipation, k and eddy currents. Some possible dimensions that demonstrate the trade-off are shown below and graphed in FIG. 5A.
   A length:
   Primary Coil Magnetic Plate Loss
      0 mm-53 W
      4 mm-53.6 W
      10 mm-54.1 W
      20 mm-54.7 W
      40 mm-55.8 W
   Primary Metallic Frame Loss:
      0 mm-5.87 W
      4 mm-4.3 W
      10 mm-3.05 W
   Based on the above criteria, A could be, for example, 10 mm providing acceptable losses on primary magnetic plates and primary metallic frames with a reasonable primary pad size.
The primary frame magnetic sheet 34 is arranged to protrude B from the primary metallic frame 31 inner perimeter/side. This protrusion decreases the eddy current loss on the metallic base plate and maintains coupling k. The more protrusion, the less eddy current losses on metallic base plate and better coupling k maintain. However, this protrusion increases pad weight, eddy current losses on metallic frames 31 and losses on coil magnetic plates. It is a trade-off between the pad size/weight, and beneficial heat dissipation, k and eddy currents. As B increases, more magnetic material is used. The size of primary frame magnetic sheet is determined by B as described above. Some possible dimensions that demonstrate the trade-off are shown below and graphed in FIG. 5B.
   B length:
   Primary Coil Magnetic Plate Loss
      0 mm-50.2 W
      4 mm-50.6 W
      10 mm-51.4 W
      20 mm-54.1 W
      40 mm-56.1 W
   Primary Metallic Frame Loss:
      0 mm-12.4 W
      4 mm-8.5 W
      10 mm-6.1 W
      20 mm-3.05 W
      40 mm-1.64 W
   k:
      0 mm-0.407
      4 mm-0.408
      10 mm-0.41
      20 mm-0.414
      40 mm-0.417
   Based on the above criteria, B could, as an example, be 20 mm to have reasonable magnetic plate losses and metallic frame losses. Coupling k is maintained at 0.414.
The gap/spacing C between primary frame magnetic sheet 34 and primary metallic frame 31 improve the heat conduction efficiency of the pad 21. The lesser the gap, the better heat conduction efficiency. However, it affects pad weight/size and increases eddy current losses on the metallic frame 31. The smaller gap between metallic frames and magnetic sheets means the higher metallic frames, which increases metallic frame weight, and vice versa. The total pad height is fixed, and therefore, the gap C changes mean the height of frame changes. Higher metallic frame means the surface of the conductor is increased, which increases the eddy current loop. Therefore, eddy current losses are increased. It is a trade-off between the pad size/weight, and beneficial heat dissipation, k and eddy currents.
The gap/spacing D between the primary frame magnetic sheet 34 and primary pad 31 cover improves the heat conduction efficiency of the pads. The less gap, the better heat conduction efficiency. However, it affects whole pad size, coupling k and eddy current losses on primary metallic frames. It is a trade-off between the gap and pros-and-cons.
The gap/spacing E between the primary metallic frame and the primary metallic base plate 33 affects eddy current losses on primary metallic base plate 33 and primary metallic frame 31. The more gap, the more losses on base plates. The total pad height is fixed, and therefore, if the gap E changes, this means the height of frame changes. As E decreases this reduces most eddy losses on the metallic base plate, with a zero E (touching of the base plate and metallic frame providing best reduction of eddy losses). Also, zero E is also the best heat dissipation position. Because it uses the maximum metal volume. However, as mentioned above, more eddy losses will be induced on the metallic frames when the height of frame increases. The weight is also increases due to increases metal volume. It is a trade-off between the pad size/weight, and beneficial heat dissipation, k and eddy currents.
The gap/spacing F between primary metallic frame 31 and the primary coil magnetic plate 36 affects eddy current losses on the primary metallic frame 31 and coupling k. The more gap, the less losses and k decreases. However, the large gap increases pad size. It is a trade-off between the pad size/weight, and beneficial heat dissipation, k and eddy currents. As F increases, the pad size increases. Some possible dimensions that demonstrate the trade-off are shown below and graphed in FIG. 5C.
   F length:
   Primary Coil Magnetic Plate Loss
      0 mm-53.5 W
      5 mm-53.9 W
      10 mm-54 W
      20 mm-54.1 W
      30 mm-52.1 W
      40 mm-51.6 W
   Primary Metallic Frame Loss:
      0 mm-12.7 W
      4 mm-4.8 W
      10 mm-4.2 W
      20 mm-3.05 W
      40 mm-2.4 W
   Large gap means large pad size and weight, but less eddy losses on metallic frame.
The thickness G of the primary metallic frame 31 affects eddy current losses on frames. The thicker of frame, the lesser the eddy current losses. However, it affects the pad sizes/weight.
The thickness H of the primary frame magnetic sheet 34 affects core losses on themselves. The thicker of sheets, the less core losses. However, thicker sheets increase whole pad weights.
The metallic frame height increasing the height improves heat dissipation but increases size and weight of pad.

### 2.2 Receiver Pad

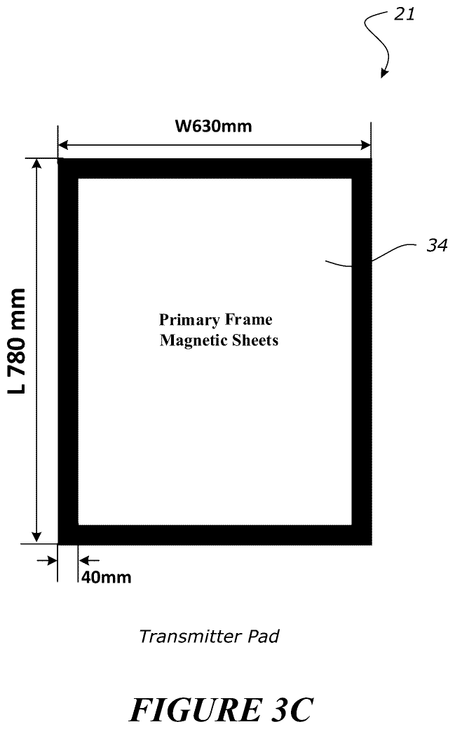

A receiver pad is shown in FIGS. 2, 4A, 4B and 4C. FIG. 4A shows a cross-section of the receiver pad 22 in diagrammatic form, FIG. 4B shows a cross-section each of the receiver pad in further detail, FIG. 4C shows a plan view of the receiver pad and FIG. 2 shows a perspective view of the receiver pad sitting above the transmitter pad. FIG. 4C shows exemplary dimensions, but this is by way of example only and should not be deemed limiting.

The receiver (pick-up) pad 22 comprises a secondary (receiver/pick-up) metallic base plate 43, and a secondary (receiver/pick-up) coil 45 sandwiched between a secondary (receiver/pick-up) pad cover 42 and a secondary (receiver/pick-up) coil magnetic plate 46. This arrangement provides for inductive power transfer from a transmitter 21 in the usual manner. The receiver pad 22 also comprises a secondary metallic frame 41 that extends as a side wall between the secondary pad cover 42 and the secondary metallic base 43, and a secondary frame magnetic sheet 44 that is disposed between the secondary metallic frame 41 and the secondary pad cover 42. The coil magnetic plate 36 and the frame magnetic sheet 44 can be made from any material with magnetic properties, such as ferromagnetic material, ferrimagnetic material, or nanocrystalline material, and can be for example ferrite, manganese-zinc ferrite, nickel-zinc ferrite etc. The coil magnetic plate and frame magnetic sheet can be made from the same or different magnetic materials.

The secondary metallic frame 41 allows for improved heat conduction in comparison to traditional secondary pads 22, but as previously noted a metallic element on its own can compromise the coupling coefficient and/or increase metallic plate losses. The combination of the secondary metallic frame 41 and secondary frame magnetic sheet 44 provide for improved heat dissipation compared to a traditional secondary transmitter pad 12, while still enabling a sufficient coupling coefficient K and enabling a reduction of losses in the metallic plates.

In particular, and similar to the transmitter pad, the secondary metallic frame 41 and the secondary frame magnetic sheet 44 can be arranged according to the following design criteria, to achieve the improved outcomes described herein. One or more of these design criteria can be applied. Not all design criteria are required, nor essential. They just provide options for more optimised solutions. Any arrangement of frame magnetic plate and metallic frame might achieve an acceptable outcome, whether or not they follow these criteria. That said, at this point, design criteria comprising dimensions I, J and N have been preferred from current simulations.

It should be noted that the trade-offs mentioned are between a criteria dimension being too big, creating a pad that is too large and/or heavy and a criteria dimension being too small to provide a benefit in terms of heat dissipation, reduction in k reduction, and reduction of eddy losses.
The secondary frame magnetic sheet 44 is arranged to protrude I from secondary metallic frame outer 41 perimeter/side. This protrusion decreases the eddy current loss on metallic frames and maintains coupling k. The more protrusion, the lesser the eddy current losses on metallic frames and better coupling k maintain. However, this protrusion increases pad sizes/weights and coil magnetic plate losses. It is a trade-off between the pad size/weight, and beneficial heat dissipation, k and eddy currents. Some possible dimensions that demonstrate the trade-off are shown below and graphed in FIG. 5D.
   For protrusion I:
   I length:
   Pickup Magnetic Plate Loss
      0 mm-42.9 W
      5 mm-44.6 W
      10 mm-45 W
      15 mm-46.25 W
      20 mm-46.9 W
      25 mm-47.7
   Pickup Metallic Frame Loss:
      0 mm-24.03 W
      5 mm-12.42 W
      10 mm-10.6 W
      15 mm-7 W
      20 mm-6.15 W
      25 mm-5.63 W
   Based on the above comparison, 10 mm is a sweet point that having acceptable losses on pickup magnetic plates and pickup metallic frames with a reasonable primary pad size.
The secondary frame magnetic sheet 44 is arranged to protrude J from secondary metallic frame 41 inner perimeter/side. This protrusion decreases the eddy current loss on the metallic base plate and maintains coupling k. The more protrusion, the lesser the eddy current losses on metallic base plate and better coupling k maintain. However, this protrusion increases pad weight, eddy current losses on metallic frames 41 and coil magnetic plate losses. It is a trade-off between the pad size/weight, and beneficial heat dissipation, k and eddy currents. As J increases, more magnetic material is used. The size of primary frame magnetic sheet is determined by J as described above. Some possible dimensions that demonstrate the trade-off are shown below and graphed in FIG. 5E.
J length:
Pickup Coil Magnetic Plate Loss
   0 mm-39 W
   4 mm-40 W
   10 mm-41 W
   20 mm-45 W
   30 mm-45.9 W
Primary Metallic Frame Loss:
   0 mm-40.22 W
   4 mm-24.23 W
   10 mm-18.54 W
   20 mm-10.6 W
   30 mm-10 W
k:
   0 mm-0.392
   4 mm-0.396
   10 mm-0.401
   20 mm-0.414
   40 mm-0.419
Based on the above comparison, J is chosen to be 20 mm to have reasonable magnetic plate losses and metallic frame losses. Coupling k is maintained at 0.414. The gap/spacing K between secondary frame magnetic sheet and secondary metallic frames improve the heat conduction efficiency of the pads. The less gap, the better heat conduction efficiency. However, it affects pad weights and increases eddy current losses on the metallic frames. The total pad height is fixed, and therefore, the gap K changes mean the height of frame changes. Higher metallic frame means more metal is used for frames that causes more weight of frames. And the surface of the conductor is increased as well, which increases the eddy current loop. Therefore, eddy current losses are increased. It is a trade-off between the pad size/weight, and beneficial heat dissipation, k and eddy currents.
The gap/spacing L between secondary frame magnetic sheet 44 and secondary pad cover 42 improves the heat conduction efficiency of the pads. The less gap, the better heat conduction efficiency. However, it affects pad size, coupling k and eddy current losses on the secondary metallic frame 41. It is a trade-off between the gap and pros-and-cons.
The gap/spacing M between secondary frame magnetic sheet 44 and secondary metallic base plate 43 affects eddy current losses on secondary metallic base plate 43 and secondary metallic frame 41. The more gap, the more losses on base plates. The total pad height is fixed here, and therefore, the gap M changes mean the height of frame changes. M can be zero (touching to each other) to reduce most eddy losses on the metallic base plate. Touching is also the best heat dissipation position because it uses the maximum metal volume. However, as mentioned above, more eddy losses will be induced on the metallic frames when the height of frame increases. The weight is also increased due to increases in metal volume. It is a trade-off between the pad size/weight, and beneficial heat dissipation, k and eddy currents.
The gap/spacing N between the secondary metallic frame 41 and secondary coil magnetic plate 46 affects eddy current losses on the secondary metallic frame and coupling k. The more gap, the less losses and k decreases. However, the large gap increases pad size. It is a trade-off between the pad size/weight, and beneficial heat dissipation, k and eddy currents. As F increases, the pad size increases. Some possible dimensions that demonstrate the trade-off are shown below and graphed in FIG. 5C.
   For gap N:
   N length:
   Pickup Magnetic Plate Loss
      5 mm-44.16 W
      10 mm-44.7 W
      20 mm-45 W
      30 mm-42.05 W
      40 mm-41.54 W
      50 mm-41.32 W
   Primary Metallic Frame Loss:
      5 mm-17.63 W
      10 mm-13.91 W
      20 mm-10.6 W
      30 mm-9.5 W
      40 mm-8.04 W
      50 mm-6.3 W
Large gap means large pad size and weight, but less eddy losses on metallic frame
The thickness O of the secondary metallic frame 41 affects eddy current losses on the secondary metallic frame 41. The thicker the frame, the less eddy current losses. However, it affects the pad size/weight.
The thickness P of secondary frame magnetic sheet 44 affects core losses on themselves. The thicker the sheets, the less core losses. However, thicker sheets increase pad weight.
The metallic frame height increasing the height improves heat dissipation but increases size and weight of pad.

### 3. Pad Materials, Design Criteria Outcomes of Embodiments

WPT pads are constructed as hermetically sealed “boxes” by base plates, frames and pad covers, such as shown in FIGS. 2 to 4C.

The primary and secondary frame magnetic sheets 34, 44 can be made of materials which are usually made by mixing and firing large portion of iron oxides blended with a small portion of one or more additional metallic elements, such as barium, manganese, nickel, zinc, etc. They are electrically nonconductive and can be easily magnetized. For example, soft ferrites can be used here, which are usually made of nickel, zinc and/or manganese compounds. They have low coercivity to be magnetized easily without dissipating much energy and high resistivity to prevent eddy currents causing much loss.

The primary and secondary frame magnetic sheets 34, 33 are placed next to metallic frames 31, 41 to help regulate magnetic flux. They regulate magnetic flux, and they are helpful to maintain the portion of linked magnetic flux between primary and pick-up coils 35, 45. They prevent the coupling coefficient k dropping due to metallic frame 31, 41 shielding. Moreover, because of flux regulating, less flux will be around metallic objects. It means lower eddy currents and lower resistive losses or solid losses on added metallic frames and base plates.

To be noted that dimensions of primary/secondary frame magnetic sheets thicknesses, A, B, C, D, J, I, H and J, can be varied depending on different sizes of WPT pads and specific cases. The lengths of A, B, C and D of added frame magnetic sheets can even be 0 mm. The performance of the proposed WPT pads will be affected more or less in terms of coupling and losses. The advantages of the proposed structure are still established.

The primary/secondary metallic frame heights, the spacing F and L between the primary/secondary metallic frames 31, 41 and the primary/secondary coil magnetic plates 36. 46, spacings E and K between the primary/secondary metallic frame 31, 41 and primary/secondary base plates 33, 43, and the spacings C and I between primary/secondary metallic frames 31, 41 and the primary/secondary frame magnetic sheets 34, 44, alleviate linked magnetic flux blocking and coupling coefficient k drop. To be noted that non-optimised frame heights, F, L, E, K, C and L cause large solid losses on frames and a significant drop in coupling coefficient k.

Traditional WPT pads 10 use galvanic insulation frames 13, 14 instead of metallic materials, to avoid coupling drops and solid losses caused by eddy currents on conductor surfaces. However, galvanic insulation materials are poor conductors of heat. The heat generated by coil losses and ferrite losses cannot be dissipated on time, and it accumulates inside of pads. Therefore the whole pads temperature goes high eventually.

The embodiments herein use metallic frames 31, 41 to dissipate heat from inside of pads to outside. Because metallic materials are good conductors of heat, frames can be made into shapes with multi-layer fins to increase conductor surface areas, which improves the heat dissipation efficiency. Typical galvanic insulation frames cannot achieve it.

By selecting dimensions as per above, a primary pad can be designed that meets the objectives of providing heat dissipation while still maintaining a desired K coefficient and reducing eddy losses.

### 4. Simulation Showing Comparative Improvements

Improvements attained by the present embodiments herein are now demonstrated by way of various simulations that compare a traditional WPT pad 10 with a WPT pad 20 according to the present embodiments.

### 4.1 Simulation Parameters

For the simulations the following specifications are used for the WPT pads—the dimensions are with reference to the letters shown in FIGS. 3B, 3C and 4B, 4C.

The ambient temperature for the simulations is 25°.

In the example, ferrite is used for frame magnetic sheet and coil magnet plate. Aluminium is used for metallic frames and base plate. The metallic materials can be any metals like aluminium, iron, or alloys. The coil magnetic plates/frame magnetic sheets can be any materials having magnetic property, like ferrimagnetic materials, ferromagnetic materials or others.

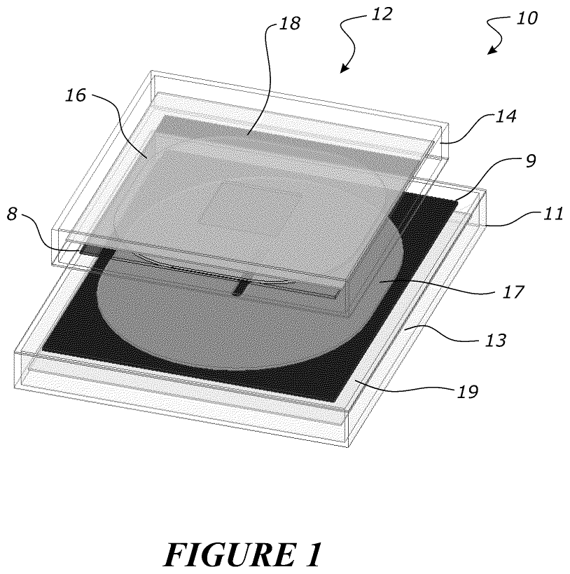

Referring to FIG. 1, the traditional WPT pads 10 specified in the simulation have the following dimensions in table 1.

TABLE 1
Dimensions of the conventional pads for simulation

| | Primary Pad | Pick-up Pad |
|---|---|---|
| Case | L780 mm, W630 mm, | L560 mm, W560 mm, |
| | H77 mm | H77 mm |
| Coil | L650 mm, W500 mm, | L450 mm, W450 mm, |
| | H5 mm | H5 mm |
| Ferrite | L700 mm, W550 mm, | L480 mm, W480 mm, |
| (magnetic) | H5 mm | H5 mm |
| plate | | |
| Aluminium | L740 mm, W590 mm, | L520 mm, W520 mm, |
| (metallic | H3 mm | H3 mm |
| frame) | | |

Referring to FIGS. 2, 3B, 3C, 4B, 4C, the WPT pads 20 according to the present embodiments and specified in the simulation have the following dimensions in table 2.

TABLE 2
Dimensions of the proposed structure for simulation

| | Primary Pad | | Pick-up Pad | |
|---|---|---|---|---|
| | see FIG. 3C | | see FIG. 4C | |
| Case Cover | L760 mm, W610 mm, | | L540 mm, W540 mm, | |
| | H3 mm | | H3 mm | |
| Metallic Frame | L760 mm, W610 mm, | | L540 mm, W540 mm, | |
| | H71 mm | | H71 mm | |
| Added Frame magnetic | L780 mm, W630 mm, | | L560 mm, W560 mm, | |
| sheets | H3 mm | | H3 mm | |
| Coil | L650 mm, W500 mm, | | L450 mm, W450 mm, | |
| | H5 mm | | H5 mm | |
| Ferrite (magnetic) plate | L700 mm, W550 mm, | | L480 mm, W480 mm, | |
| | H5 mm | | H5 mm | |
| Aluminium (metallic) | L740 mm, W590 mm, | | L520 mm, W520 mm, | |
| frame | H3 | mm | H3 | mm |
| A/I (PRIMARY/ | 10 | mm | 10 | mm |
| PICK-UP) | | | | |
| B/J | 20 | mm | 20 | mm |
| C/K | 0 | mm | 0 | mm |
| D/L | 0 | mm | 0 | mm |
| E/M | 0 | mm | 0 | mm |
| F/N | 20 | mm | 20 | mm |
| FRAME THICKNESS | 10 | mm | 10 | mm |
| G/O | | | | |
| Base plate to ferrite | 30 | mm | 30 | mm |

Zero (0) mm is used for C/K, D/L, E/M as this was found optimum. It is easier to assembly a pad with 0 mm for these dimensions. If there is a gap, a filler material is required and assembly needs to be considered.

The losses on the frame magnetic sheets and metallic frame are also specified for the simulations, as set out in table 3 below.

TABLE 2
Losses used for the simulations

| Loss (W) | Conventional Pad | | Proposed Pad | |
|---|---|---|---|---|
| @Iₚₜ = 90 A Iₛₜ = 60 A | Primary | Pick-up | Primary | Pick-up |
| Ferrite Plate | 48 | 41.9 | 54.1 | 44.97 |
| Added Frame magnetic | N/A | | 1.76 | 5.34 |
| sheet | | | | |
| Metallic Plate | 4.66 | 15.11 | 0.09 | 0.23 |
| Metallic Frame | N/A | | 3.01 | 11.418 W |
| Coil | 45.18 | 25.24 | 45.18 | 25.24 |
| Sum | 180.09 | | 191.3 W | |

### 4.2 Heat Dissipation Comparison

A simulation of heat dissipation was run on the pads specified above. This shows the improvement of heat dissipation between a WPT pad with a metallic frame as per the present embodiments, and a traditional pad without a metallic frame.

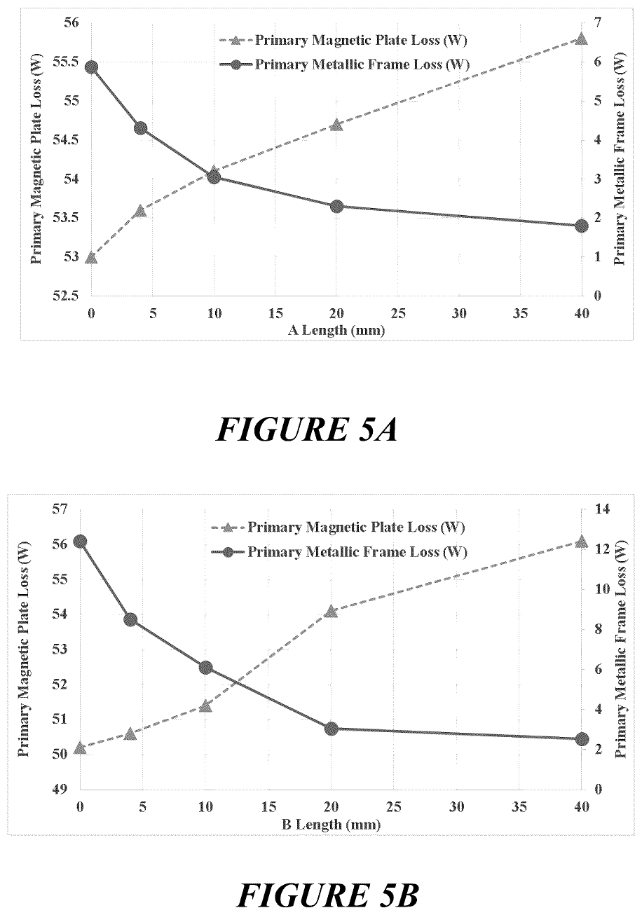

FIGS. 6A, 6B demonstrate the heat dissipation improvements attained by the present embodiments as specified above in heat dissipation by way of a comparison of a simulation of a traditional WPT transmitter/receiver pad 10 (11, 12) with a simulation of a WPT transmitter/receiver pad 20 (21, 22) according to present embodiments. The temperature of the magnetic plates, coils, metallic plates, metallic frames and covers are all less for the WPT pads 20 as per the present embodiments, than for the traditional WPT pad 10. The arrangement of the present embodiments clearly provide an improved heat dissipation.

### 4.3 Magnetic Flux Coupling (k Coupling Coefficient) Comparison

As noted, above the metallic frame can reduce k, but the addition of the frame magnetic sheet can alleviate this. A simulation of electromagnetic coupling was run on the WPT pad as per the present embodiments (and dimensions above), and another without the frame magnetic sheet (but same dimensions).

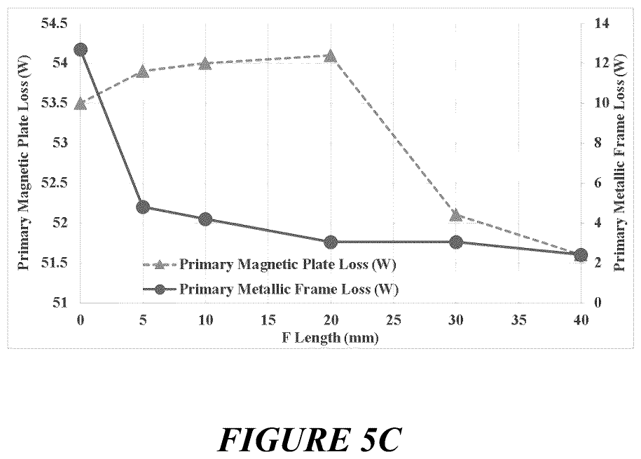

FIG. 7 shows the outcome of the simulation and demonstrates the magnetic flux coupling (k) improvements attained by the present embodiments as specified above by way of a comparison of a simulation of a WPT receiver pad 12 without a frame magnetic sheet with a simulation of a WPT receiver pad 22 with a magnetic sheet according to present embodiments.

The WPT pads 20 as per the present embodiments with dimensions as per the design criteria help to alleviate magnetic flux blocking due to metallic frames and keep coupling coefficients k. The comparison of k is given in Table 4 from simulation results.

TABLE 4
Comparison of Coupling Coefficient k between two WPT
pads, one with frame magnetic sheet and one without

| | With Added | Without Added |
|---|---|---|
| | Magnetic | Magnetic |
| | Sheets | Sheets |
| Coupling k | 0.41 | 0.37 |
| Primary Base Plate Eddy | 0.092 W | 0.127 W |
| Losses | | |
| Primary Frame Eddy | 3.05 W | 12.154 W |
| Losses | | |
| Pick-up Base Plate Eddy | 0.245 W | 0.391 W |
| Losses | | |
| Pick-up Frame Eddy | 11.418 W | 44.23 W |
| Losses | | |

In the WPT pads 20, the frame magnetic sheets 34, 44 regulate a portion of magnetic flux into the linked flux between primary coil 35 and pick-up coil 45. The metallic frames 31, 41 and the magnetic sheets 34, 44 with dimensions as per the design criteria leave enough space to prevent magnetic flux blocking. The coupling between the two coils 35, 45 is maintained.

The magnetic flux outside of the pick-up frame 41 is regulated through the added magnetic sheet 44 as shown in FIG. 4B. Both portion and magnitude of magnetic flux linked between the primary coil 35 and the pick-up coil 45 are increased and strengthened. This is the reason that coupling coefficient k is higher with the embodiments herein. One purpose of the embodiments is to prevent coupling coefficient k decrease.

### 4.4 Reduced Solid Losses Due to Eddy Currents Comparison

As noted, above the metallic frame can reduce eddy current losses in the magnetic plate, but introduce new eddy currents, but the addition of the frame magnetic sheet can alleviate this. A simulation of electromagnetic coupling was run on the WPT pad as per the present embodiments (and dimensions above), and another without the frame magnetic sheet (but same dimensions).

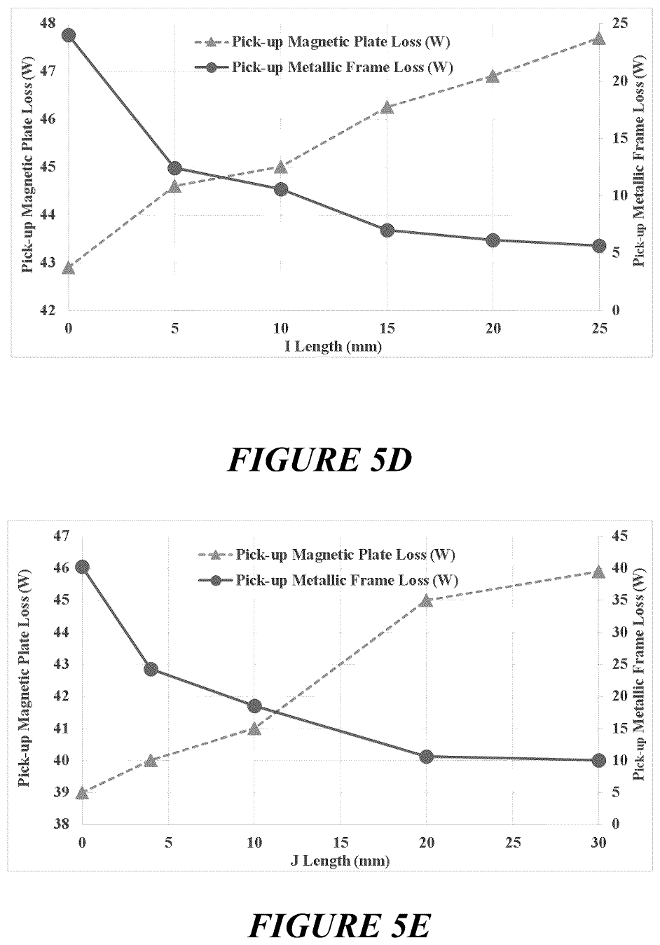

FIG. 8 shows the outcome of the simulation and demonstrates the eddy current loss improvements attained by the present embodiments as specified above by way of a comparison of a simulation of a WPT transmitter and receiver pad without a frame magnetic sheet with a simulation of a WPT transmitter 21 pad and receiver pad 22 with a magnetic sheet according to present embodiments

In summary.
Frame only (no frame magnetic sheets):
   Primary base plate loss: 0.1277 W
   Pickup base plate loss: 0.3913 W
   Primary frame loss: 12.1546 W
   Pickup frame loss: 44.2286 W
With frame magnetic sheets
   Primary base plate loss: 0.0924 W
   Pickup base plate loss: 0.2456 W
   Primary frame loss: 3.05 W
   Pickup frame loss: 11.418 W

So the frame magnetic sheets reduce the eddy currents generated in the magnetic frame. And, as mentioned earlier, the metallic frame also reduces eddy currents in the metallic plate. So, the addition of the metallic frame and frame magnetic sheet (which helps reduce eddy currents in the metal frame), means that the total eddy current losses of the metallic frame and metallic plate are less than the eddy current losses in just the metallic plate of a traditional WPT pad 10.

The WPT pads as per the present embodiments also provide eddy loss improvements over a traditional WPT pad. In another simulation, the results demonstrate this, where the eddy losses of the present embodiment is compared to the eddy losses of a traditional WPT pad, as follows.
Traditional pads:
   Primary base plate loss: 4.96 W
   Pickup base plate loss: 15.58 W
   Total: 20.54 W
Proposed WPT pads:
   Primary base plate loss: 0.0924 W
   Pickup base plate loss: 0.2456 W
   Primary frame loss: 3.05 W
   Pickup frame loss: 11.418 W
   Total: 14.806 W

### 4.5 Other k Observations

A simulation of k was run on the pads specified above. This shows the relative k (coupling coefficient) between a WPT pad with a metallic frame and frame magnetic sheet as per the present embodiments, and a traditional pad without a metallic frame and magnetic sheet.

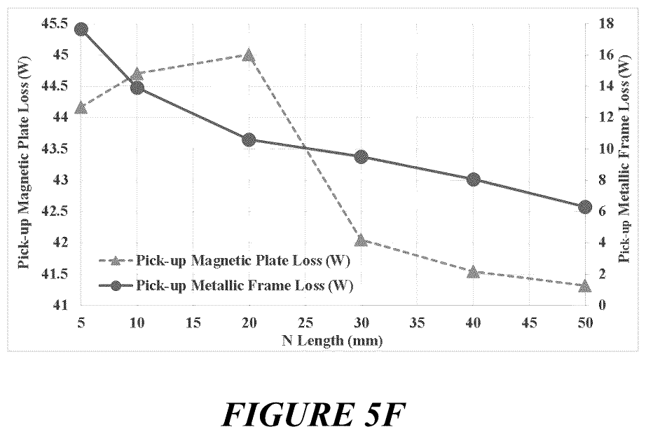

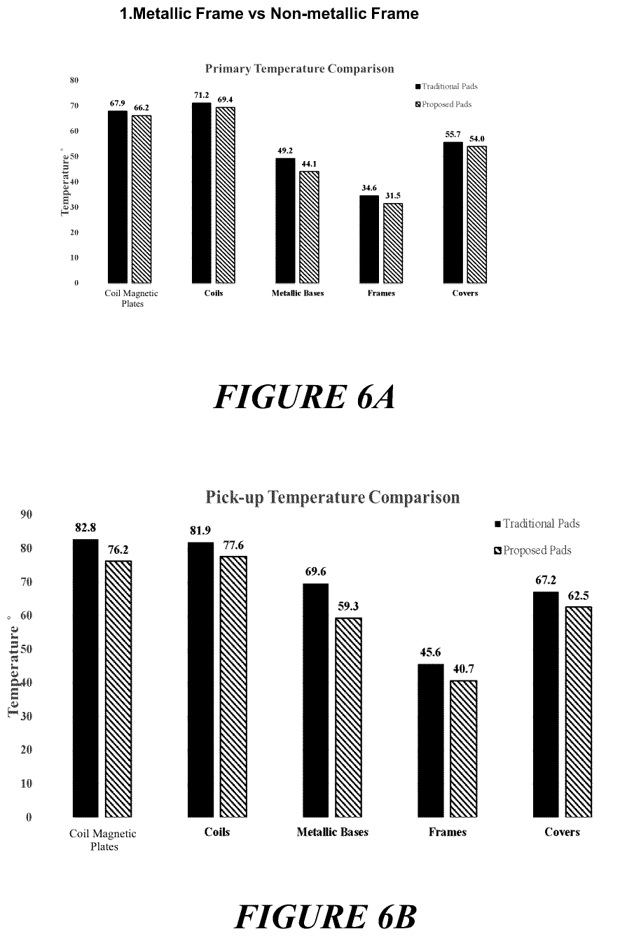

FIGS. 9A, 9B and 10A, 10B demonstrate the magnetic flux coupling (k) attained by the present embodiments as specified above by way of a comparison of a simulation of a traditional WPT receiver pad 12 with a simulation of a WPT receiver pad 22 according to present embodiments. This shows that k is at least maintained in the present embodiments, and is even slightly improved.

The WPT pads 20 as per the present embodiments with dimensions as per the design criteria help to alleviate magnetic flux blocking due to metallic frames and keep coupling coefficients k. The comparison of k is given in Table 5 from simulation results.

TABLE 5
Comparison of Coupling Coefficient k between two WPT pads

| | Typical WPT Pads | Proposed WPT pads |
|---|---|---|
| Coupling coefficient k | 0.402 | 0.414 |

In the WPT pads 20, the frame magnetic sheet 34, 44 regulates a portion of magnetic flux into the linked flux between primary coil 35 and pick-up coil 45. The metallic frames 31, 41 and the frame magnetic sheets 34, 44 with dimensions as per the design criteria leave enough space to prevent magnetic flux blocking. The coupling between the two coils 35, 45 is maintained. This is shown in FIG. 10A, 10B. In comparison, the magnetic flux demonstration of the typical WPT pad 10 using galvanic insulation frames 13,14 is shown in FIG. 10A, 10B.

The magnetic flux outside of the pick-up frame 41 is regulated through added the frame magnetic sheet 44 as shown in FIG. 4B. Both portion and magnitude of magnetic flux linked between the primary coil 35 and the pick-up coil 45 are increased and strengthened. This is the reason that coupling coefficient k is higher with the embodiments herein. One purpose of the embodiments is to prevent coupling coefficient k decrease.

Traditional WPT pads 10 with galvanic insulation frames 13, 14 have high magnetic flux density around edges of the metallic base plate, as shown in FIG. 9A, 9B. Because the flux is neither blocked by metallic objects nor redirected by the added frame magnetic sheet. As a result, it causes high ohmic-losses measured in W/m³ or solid losses. The ohmic-loss on the pick-up base plate is plotted in FIG. 6B. In contrast, there is a low magnetic flux density around the edges of the metallic base plate 43, shown in FIG. 7B. Therefore, the ohmic-loss is lower, as shown compared to the traditional WPT pick-up pad.

The solid loss comparison between the traditional WPT pad 10 and the present embodiments 20 is given in the table below. The solid losses on the metallic base plates can be significantly reduced from 4.66 W to 0.09 W on the primary side, and 15.11 W to 0.23 W on the pick-up side by using the proposed structure. Although the metallic frame brings 3.01 W and 10.58 W extra solid loss on both sides, the total solid loss decreases from 19.77 W to 13.91 W. It is almost 30% solid loss reduction, and the efficiency of the WPT system can be improved with the proposed WPT pad structure. In other words, pads with the proposed structure are cooler than traditional WPT pads in terms of temperature.

TABLE 6
Solid Losses Comparison

| | Loss | | Loss | Loss | |
|---|---|---|---|---|---|
| | on the | Loss | on the | on the | |
| | primary | on the | pick-up | metallic | |
| | base plate | primary | base | pick-up | Total |
| | (W) | frame (W) | plate (W) | frame (W) | (W) |
| Typical | 4.66 W | NULL | 15.11 W | NULL | 19.77 W |
| WPT | | | | | |
| Pads | | | | | |
| Proposed | 0.09 W | 3.01 W | 0.23 W | 10.58 W | 13.91 W |
| WPT | | | | | |
| Pads | | | | | |

### 6. Embodiment with Air Blown (Fan) Cooling

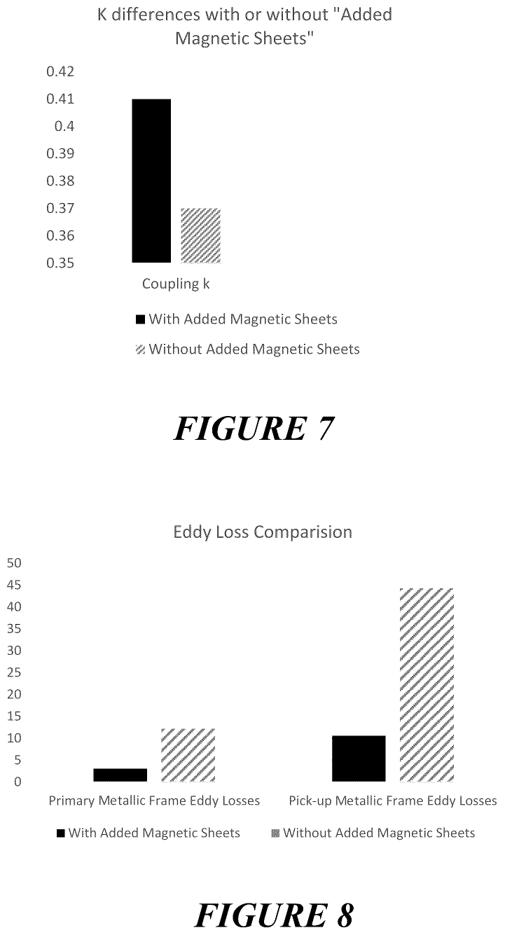

Referring to FIGS. 11A, 11B, 12A, 12B, 13A, 13B, 14A, 14B in a further embodiment an air blown cooler (e.g. fan) 80, 81 can be incorporated into the transmitter 21′ and/or receiver pad 22′ to improve heat dissipation. The fan provides airflow inside the primary pad 21′ and on top of the pick-up pad 22′, which helps fast heat conductions. The air circulating inside the pick-up pads through the opening improves heat conduction.

### 6.1 Heat Dissipation Comparison

A simulation of heat dissipation was run on the pads 10′, 20′ specified above.

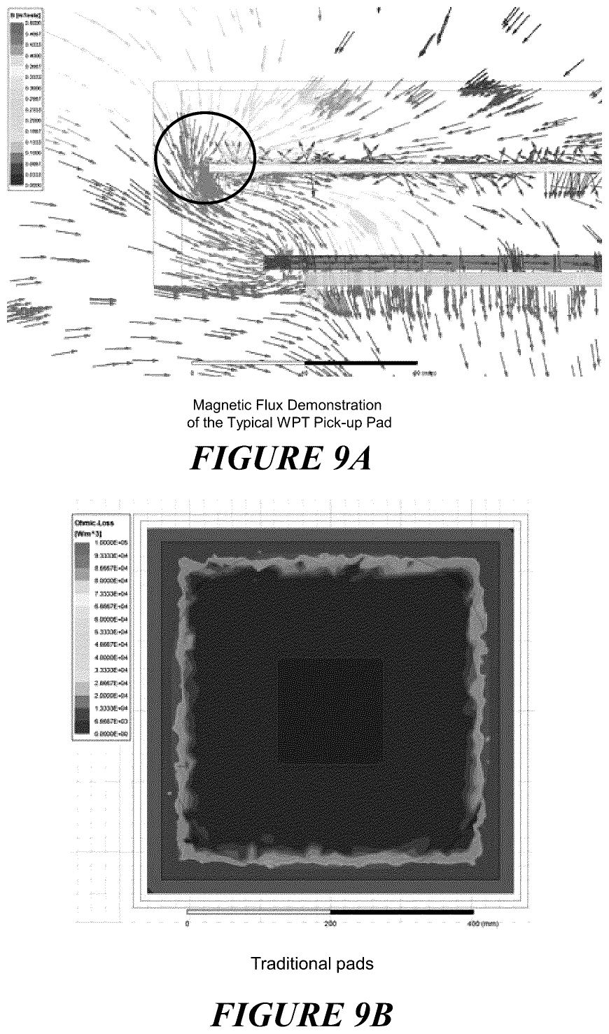

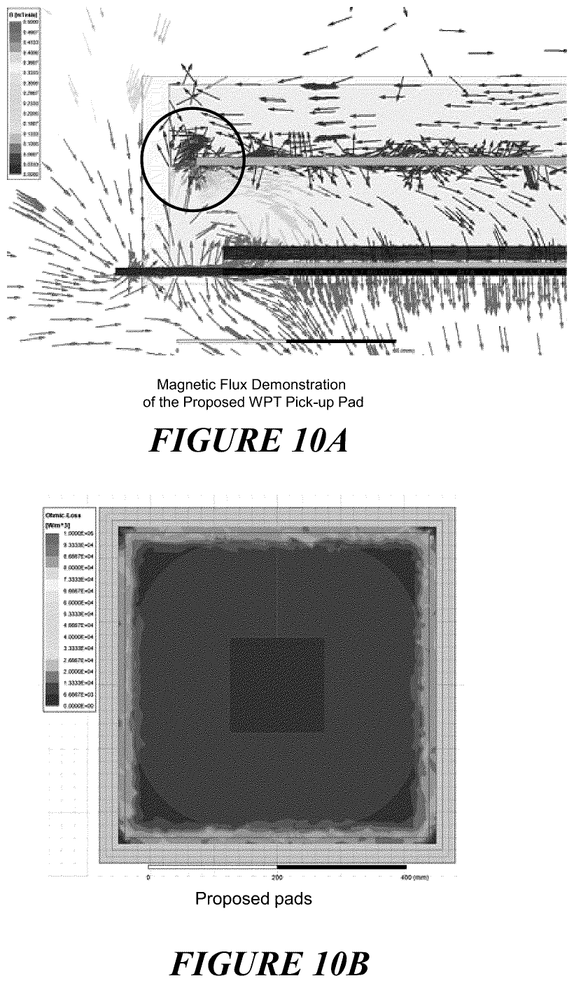

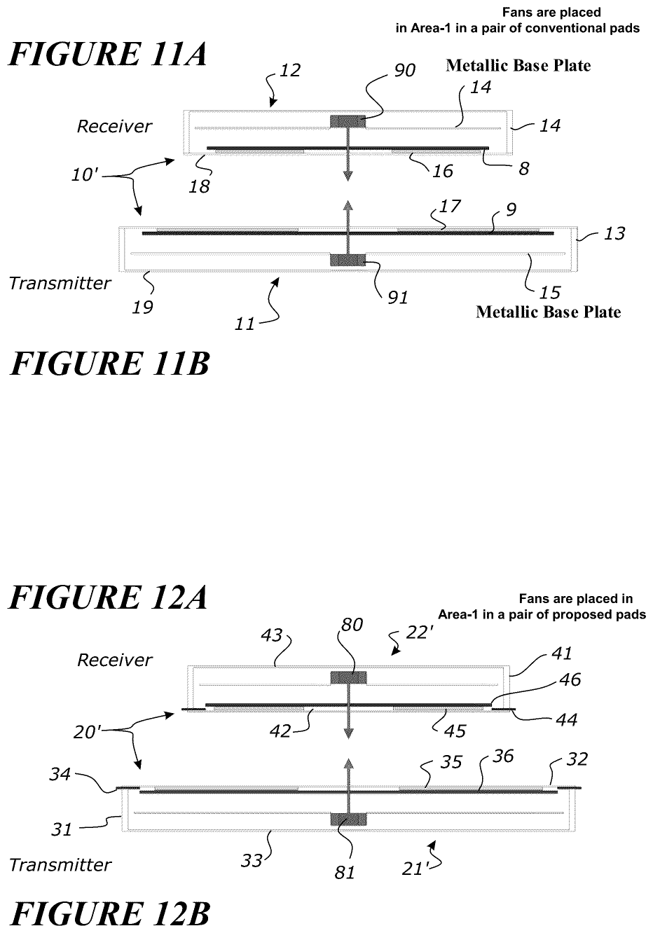

There are two areas where a fans can be placed:
Area-1 is the area behind metallic base plate in a WPT transmitter/receiver pad. See FIGS. 11A, 11B, 12A, 12B.
   FIG. 11A, 11B: traditional pad 10. A fan 90, 91 (block) is added in Area-1 on a pair of conventional pads 10′. Arrows are air flow directions. Openings are added on the metallic base plates to allow higher air flow.
   FIG. 12A, 12B: present embodiment pad. A fan 80, 81 (block) is added Area-1 on a pair of pads 20′ as per the present embodiments. Arrows are air flow directions. Openings are added on the metallic base plates to allow air blowing in.
Area-2 is the area between the metallic base plate and the coil magnetic plate in a WPT transmitter/receiver pad. See FIGS. 13A, 13B, 14A, 14B. This can make the pad thinner.
   FIG. 13A, 13B: convention pad. A fan 90, 91 (block) is added in Area-2 (between metallic base plate and coil magnetic plate) on a pair of conventional wireless power transferring pad. Arrows are air flow directions. Openings are added on the metallic base plates to allow higher air flow.
   FIG. 14A,14B: present embodiment pad. A fan 80, 81 (block) is added in Area-2 (between metallic base plate and coil magnetic plate) on a pair of conventional wireless power transferring pad. Arrows are air flow directions. Openings are added on the metallic base plates to allow higher air flow.

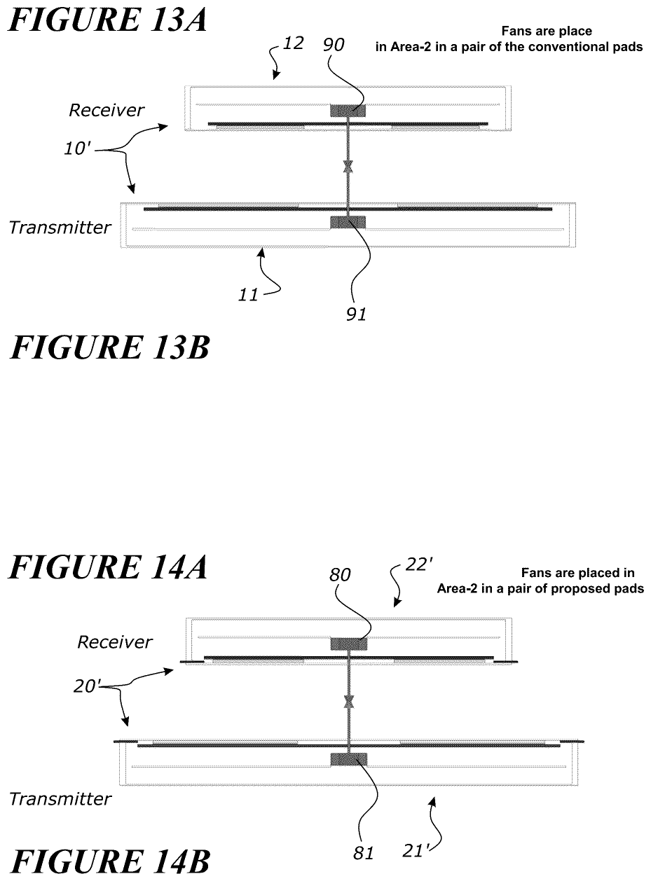

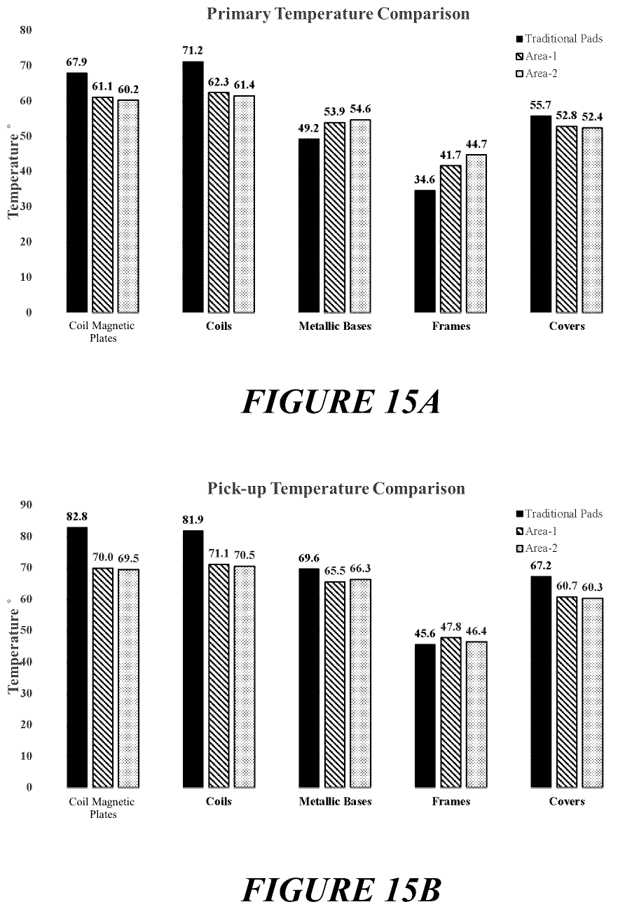

A first simulation of heat dissipation was run on the air blown cooled pads 10′, 20′ as per above, with the fans arranged in the area 1 behind the metallic base plate as per FIGS. 11A, 11B (traditional pad) and 12A, 12B (pad as per present embodiments). The same simulation specifications were used as set out previously for the non-fan cooled embodiment. See FIGS. 15A, 15B, 16A, 16B for results.

A second simulation of heat dissipation was run on the air blown cooled pads 10′, 20′ as per above, with the fans arranged in the area 2 between the metallic base plate and the coil magnetic plate as per the same simulation specifications were used as set out previously for the non-fan cooled embodiment.

FIGS. 15A to 16B show that:
Placing a fan in either a primary pad or a secondary pad can reduce the temperature rises on the coil magnetic plate and coil inside the pad.
Placing a fan in area-1 and placing a fan in area-2 have similar effectiveness
Placing a fan in either a conventional pad or a proposed pad can reduce the temperature rises on the ferrite plate and coil inside the pad.

In summary, a fan can be used in either the traditional WPT pads and/or WPT pads according to the present embodiments to improve heat dissipation. Multiple fans can be used in either area. It is possible to select either area or both areas to place a fan or fans. Using area-2 only for a fan can reduce the thickness of a pad to accommodate a fan(s).

### 7. Embodiment with Liquid Cooling

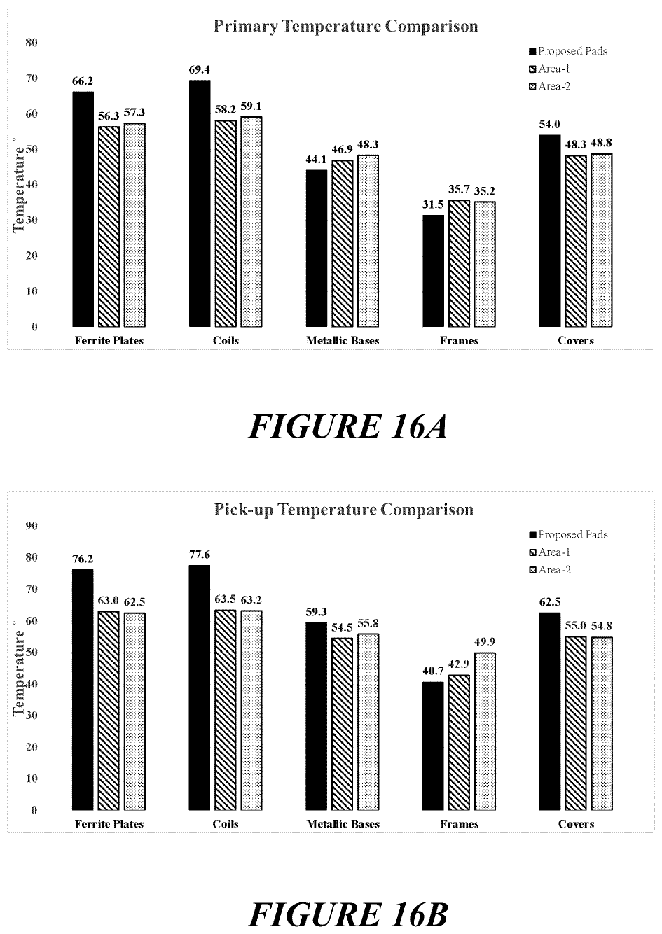

Referring to FIGS. 17A, 17B, in a further embodiment liquid cooling 130, 131 can be incorporated into the pad 20″ (transmitter 21″ and/or receiver pad 22″) to improve heat dissipation. This can be in addition to or instead of the air blown cooling 80, 81.

Liquid cooling systems can be implemented with cooling pipes 130, 131 attaching to metallic frames. Two examples are shown in FIGS. 17A, 17B. In the first, liquid cooling pipes 130 are embedded inside metallic frames. In the second, pipes 131 are attached to the surface of metallic frames. The pipes can also put on the other side of metallic frames (ferrite plate side).

### 8. Embodiment with Heat Sink Cooling

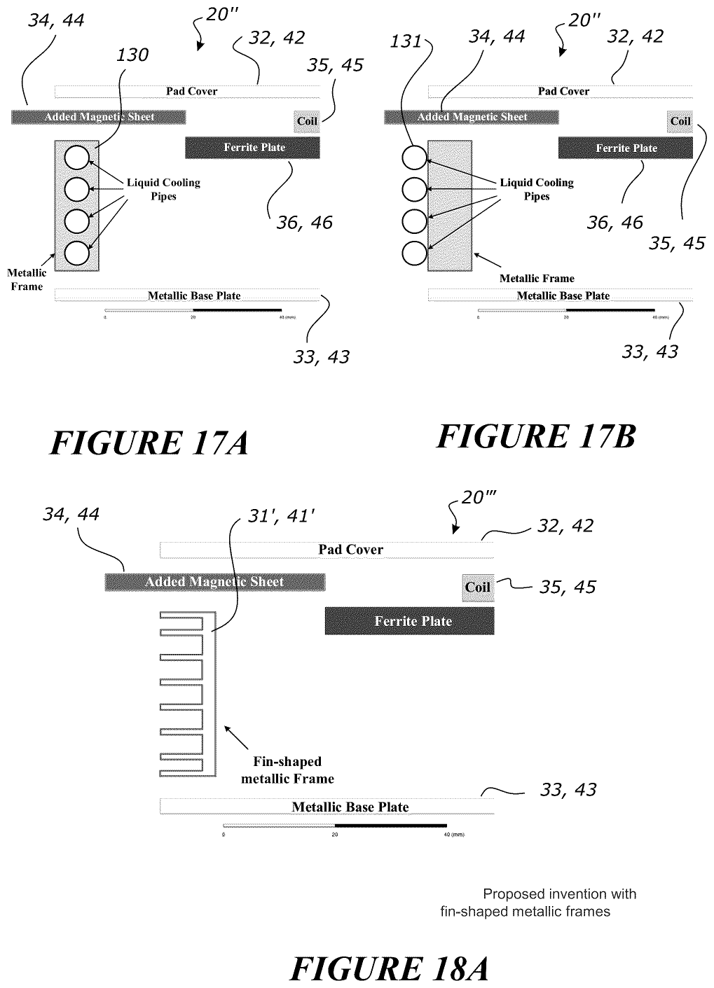

Referring to FIG. 18A, in a further embodiment heat sink cooling can be incorporated into the pad 20′″ (transmitter 21′″ and/or receiver pad 22′″) to improve heat dissipation. This can be in addition to or instead of the air blown cooling and/or liquid cooling.

The metallic frames 31′, 41′, can be made to any shapes that increase conductor surface to help improve heat dissipation efficiencies. In effect, the metallic frames 31′, 41′ become heat sinks. An example is shown in FIG. 18A. The fin-shaped metallic frame has a similar shape to traditional heat sinks.

### 9. Variations

The pad could be filled or partially filled with potting compound, such as epoxy, which has a higher thermal conductivity than air and thus assists in dissipating heat. For embodiments with air-blown fan cooling, the potting may be confined to the area surrounding the coil and magnetic plate. The addition of potting may also improve structural rigidity, especially for the air-blown fan cooling embodiments where the potting surrounds the coil and magnetic plate.

It is not essential for the transmitter pad nor the receiver pad to have a metallic base plate. Rather the cover could be more in the form of a housing and provide the base plate too, thus encompassing the coil, and/or metallic frame and/or frame magnetic sheet and/or coil magnetic sheet and/or fan and other components as appropriate.

Where a pad has a metallic base plate, the cover might encapsulate the base plate.

It is not essential for the transmitter pad nor the receiver pad to have a coil magnetic sheet.

Therefore, the transmitter pad and/or receiver pad might just comprise a coil, cover, metallic frame and frame magnetic sheet.

### 10. Outcomes

The embodiments described do the following
Use metallic frame to improve heat dissipation.
Use frame magnetic sheet structure to help heat dissipation and minimise eddy loss occurs on the metallic frame and to improve k.
Place fans inside to help heat dissipations.
One or multiple fans can be placed inside a wireless power transferring pad.
A fan can be air out-taking (blowing) or air in-taking (sucking)
Both methods have good effectiveness to reduce the temperature rises on the coil and coil magnetic plate in a wireless power transferring pad.
Two methods can be applied independently or together.

1. A WPT transmitter pad comprising:
a cover,
a coil,
a metallic frame, and
a frame magnetic sheet between the metallic frame and the cover.

2. A WPT transmitter pad according to claim 1 further comprising a metallic base plate.

3. A WPT transmitter pad according to claim 1 or 2 further comprising a coil magnetic plate.

4. A WPT transmitter pad according to any preceding claim wherein the frame magnetic sheet extends beyond the external perimeter of the metallic frame.

5. A WPT transmitter pad according to any preceding claim wherein the frame magnetic sheet extends beyond the internal perimeter of the metallic frame.

6. A WPT transmitter pad according to any preceding claim wherein the frame magnetic sheet is disposed between the metallic frame and the cover.

7. A WPT transmitter pad according to any preceding claim wherein the frame magnetic sheet is spaced from the cover.

8. A WPT transmitter pad according to any preceding claim wherein the frame magnetic sheet is spaced from the metallic frame.

9. A WPT transmitter pad according to any preceding claim wherein the frame magnetic sheet is spaced from the coil magnetic plate.

10. A WPT transmitter pad according to any preceding claim wherein the metallic frame is spaced from the frame magnetic sheet.

11. A WPT transmitter pad according to any preceding claim wherein the metallic frame is spaced from the metallic base plate.

12. A WPT transmitter pad according to any preceding claim wherein the metallic frame is spaced from the coil magnetic plate.

13. A WPT transmitter pad according to any preceding claim wherein the metallic frame is shaped to improve heat dissipation.

14. A WPT transmitter pad according to any preceding claim further comprising one or more fans.

15. A WPT transmitter pad according to any preceding claim further comprising liquid cooling.

16. A WPT transmitter pad according to any preceding claim wherein the frame magnetic sheet and/or coil magnetic plate are made from one or more of:
ferromagnetic material,
ferrimagnetic material, or
nanocrystalline material,
and/or can be for example be:
ferrite,
manganese-zinc ferrite,
nickel-zinc ferrite.

17. A WPT receiver pad comprising:
a cover,
a coil,
a metallic frame, and
a frame magnetic sheet between the metallic frame and the cover.

18. A WPT receiver pad according to claim 17 further comprising a metallic base plate.

19. A WPT receiver pad according to claim 17 or 18 further comprising a coil magnetic plate.

20. A WPT receiver pad according to any preceding claim wherein the frame magnetic sheet extends beyond the external perimeter of the metallic frame.

21. A WPT receiver pad according to any preceding claim wherein the frame magnetic sheet extends beyond the internal perimeter of the metallic frame.

22. A WPT receiver pad according to any preceding claim wherein the frame magnetic sheet is disposed between the metallic frame and the cover.

23. A WPT receiver pad according to any preceding claim wherein the frame magnetic sheet is spaced from the cover.

24. A WPT receiver pad according to any preceding claim wherein the frame magnetic sheet is spaced from the metallic frame.

25. A WPT receiver pad according to any preceding claim wherein the frame magnetic sheet is spaced from the coil magnetic plate.

26. A WPT receiver pad according to any preceding claim wherein the metallic frame is spaced from the frame magnetic sheet.

27. A WPT receiver pad according to any preceding claim wherein the metallic frame is spaced from the metallic base plate.

28. A WPT receiver pad according to any preceding claim wherein the metallic frame is spaced from the coil magnetic plate.

29. A WPT receiver pad according to any preceding claim wherein the metallic frame is shaped to improve heat dissipation.

30. A WPT receiver pad according to any preceding claim further comprising one or more fans.

31. A WPT receiver pad according to any preceding claim further comprising liquid cooling.

32. A WPT receiver pad according to any preceding claim wherein the frame magnetic sheet and/or coil magnetic plate are made from one or more of:
ferromagnetic material,
ferrimagnetic material, or
nanocrystalline material,
and/or can be for example be:
ferrite,
manganese-zinc ferrite,
nickel-zinc ferrite.

33. A WPT system comprising a transmitter pad according to any of the preceding claims and a receiver pad according to any of the preceding claims.

34. A WPT pad comprising:
a cover,
a coil,
a metallic frame, and
a frame magnetic sheet between the metallic frame and the cover.

35. A WPT pad according to any preceding claim comprising potting compound to assist in dissipating heat.
